(19) United States
(12) Patent Application Publication
(10) Pub. No.: US 2002/0042910 A1
(43) Pub. Date: Apr. 11, 2002

(54) Method of detecting write conflicts in replicated databases without memory overhead

(76) Inventors: Markus Baumeister, Aachen (DE); Steffen Hauptmann, Aachen (DE); Karin Klabunde, Aachen (DE)

Correspondence Address: Corporate Patent Counsel, U.S. Philips Corporation, 580 White Plains Road, Tarrytown, NY, 10591, US

(21) Appl. No.: 09/961,956

(22) Filed: Sep. 24, 2001

(30) Foreign Application Priority Data
Sep. 23, 2000 (DE) 10047216.8

(51) Int. Cl. G06F 9/445

(52) U.S. Cl. 717/172

(57) ABSTRACT

The invention relates to a network comprising network nodes (1 to 3) and to a software system distributed over all the network nodes which comprises a database management system (7 to 9) which is provided for calculating a characterizing unit of the data object when a user, referred to as a client (10 to 12), of the database management system (7 to 9) accesses a data object, and the characterizing unit is provided for being transferred to the client (10 to 12) and the client (10 to 12) is provided for storing the characterizing unit.

The invention relates to a network comprising network nodes and to a software system comprising a database management system, which software system is distributed over all the network nodes.

Such a network is known from Ralf Steinmetz (publishers): “Kommunikation in verteilten Systemen (KiVS)”, 11^{th} ITG/GI Symposium, Darmstadt, Mar. 2-5, 1999, Stephan Abramowski, Heribert Baldus, Tobias Helbig: “Digitale Netze in Wohnungen—Unterhaltungselektronik im Umbruch”, pp. 340 to 351. In this publication requirements are described for a future network in the home area with the software used therein. How write conflicts in databases are detected in such a network with a distributed software system is not further discussed.

It is an object of the invention to provide a network comprising a software system which avoids a data loss and thus solves the so-called lost update problem if different users, the so-called clients, of the distributed software system simultaneously have write access to the database.

The object is achieved by a network of the type defined in the opening paragraph in that the software system comprises a database management system which is provided for calculating a characterizing unit of the data object when a user referred to as a client accesses a data object of the database management system, and the characterizing unit is provided for being transferred to the client and the client is provided for storing the characterizing unit.

In a network comprising network nodes and a software system distributed over all the network nodes, a database management system takes care of the data transfer as an interface between program (for application) and data. In databases, whose task is, for example, the management of user and administration data as well as the presetting of apparatus in digital home networks, problems may arise from two contending read/write accesses of two clients, which problems often result in data loss and are referred to as so-called lost update problems in the literature. Data losses are caused by the fact that data that were written by a first writing client, are overwritten by a second writing client, without the latter having read the data written by the first client.

With each read access to a data object a client (for example, a client behind whom there is an application) receives the actual data object together with a characterizing unit calculated by the database management system, which characterizing unit characterizes the data object, for example, in the form of a CRC checksum (Cyclic Redundancy Check) or a hash value, and needs a considerably smaller amount of memory space than this data object. If the client intends to make a change of the data object, he will briefly store the characterizing unit to deliver this characterizing unit to the database management system together with the changed data object when the write access is there.

Before this write access takes place, the database management system compares the characterizing unit delivered to it by the client with the current characterizing unit calculated by the database management system. If the two characterizing units match, the write access of the client is carried out. If the comparison has a negative result and the characterizing units do not match, the database management system executes alternative actions, for example, the write access is refused or a merge of the data is attempted.

The client changes the data object during a processing and in the case of a distributed write operation sends a change indication together with the characterizing unit in a message to the database management system.

In a network comprising data objects identified by characterizing units, it is not necessary to have a central co-ordination unit for the write accesses to data. The detection of conflicts takes place during the write request and the additional information necessary for this can be transmitted via the change data; no additional communication is necessary therefor. Since the characterizing unit can always be calculated from the data stored in the database, no information for detecting write conflicts need be stored in the database either. In consequence, the database management system need not store the status data for securing data in the case of a failure of the network nodes, nor store time data about recently stored data for the detection of conflicts.

These and other aspects of the invention are apparent from and will be elucidated with reference to the embodiments described hereinafter.

In the drawings:

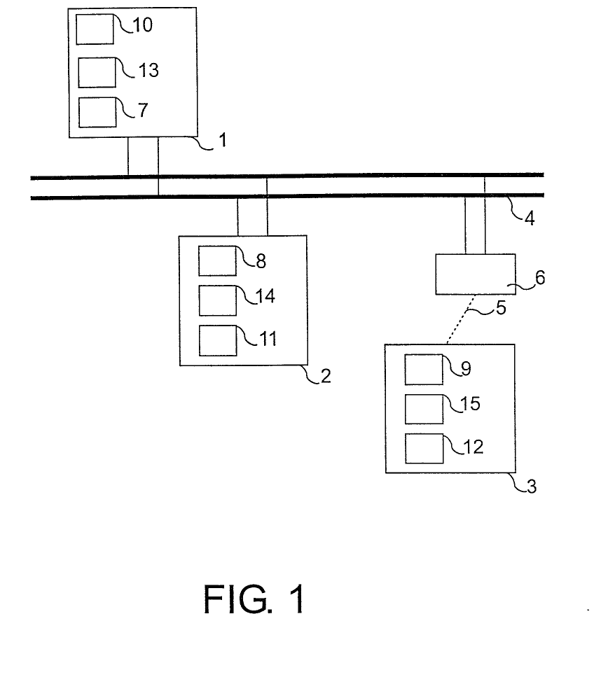

FIG. 1 shows a network comprising a plurality of network nodes,

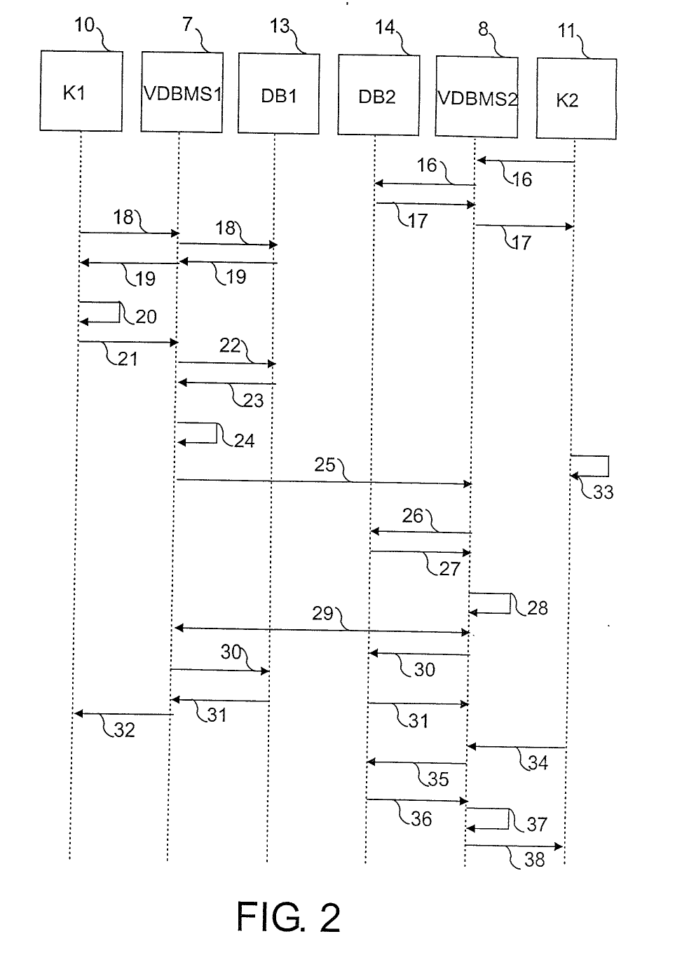

FIG. 2 shows a signaling flow chart to represent the order of the actions during a client's write access to a data object.

FIG. 1 shows a network in which a plurality of network nodes 1 to 3 are coupled to each other by a bus system 4. The bus system 4 may also be any type of network topology or communication system. The network nodes 1 to 3 may also be coupled to the bus system 4 via a wireless connection 5 and a transceiver station 6. For this purpose, for example, infrared, ultrashell or radio links may be used. Such network nodes may be PCs and apparatus of entertainment electronics such as, for example, a television set, set top box, tuner, camera, digital video recorder, CD player and so on.

At each of the three network nodes 1 to 3 there are a distributed database management system 7 to 9 and at least one client 10 to 12. In addition, there may be a distributed database 13 to 15 at the network nodes 1 to 3.

FIG. 2 clarifies the actions during a client's write access to a data object. In this example, the client (K1) 10 of the network node 1 and client (K2) 11 of the network node 2 both access a data (data element) stored under a cipher key S1. A data object in the database can be identified by means of the cipher key. Both client 10 and client 11 would like to read the data object, locally change it at the respective network node and then overwrite the read data object with the changed data object, so that the change is retained throughout the system.

The client 11 asks the distributed database management system (VDBMS2) 8 for the data object stored under the cipher key S1 via a request 16 which includes the cipher key S1. The database management system 8 transfers the request 16, for example, to its local database (DB2) 14, which returns the data object to the database management system 8 via a reply 17. The database management system 8 conveys the reply 17 with the data object and a characterizing unit calculated from the data object to the client 11. The characterizing unit in this example consists of a checksum CRC 1.

Similarly, the client 10 reads the data object from the local database (DB1) 13 with a request 18 via the database management system (VDBMS1) 7. Together with the data object coming from the local database 13, also a checksum CRC1 in a reply 19 given by the database management system 7 is delivered to this client 10. Since the data in the two local databases 13 and 14 were equal, both clients 10 and 11 receive the same characterizing unit CRC1.

The client 10 changes the data object during a processing 20 and then sends the changed data object together with the cipher key S1 and the original checksum CRC1 in a request 21 to the database management system 7, so that the changed data object can be stored under the cipher key S1. Subsequently, the database management system 7 asks, via a request 22, for the data object stored under the cipher key S1 from its local database 13. In a reply 23 the database management system 7 receives the desired data object from the local database 13 and calculates its checksum CRC1 in a self-interrogation 24.

If the most recently calculated checksum CRC1 matches the checksum CRC1 sent to the database management system 7 by the client 10 in the request 21, the data has meanwhile not been changed and the data object can be overwritten throughout the system without a so-called lost update problem arising. If a replica of the data is present, the check of the characterizing unit is to be made in the framework of a two-phase commit protocol. The two-phase commit protocol is used with so-called transactions (a matching sequence of operations accessing a database) which work with distributed databases. The change and also the characterizing unit is then transmitted to all the replica locations and processed there similarly to the non-replicated case. In the example the database management system 7 therefore sends a change request 25 to the database management system 8. The latter reads the data concerned from the local database 14 by means of a request 26 and a return 27 of the database 14. Subsequently, the database management system 8 calculates the characterizing unit via a self-interrogation 28. If this characterizing unit matches the transmitted characterizing unit, the database management system 8 prepares the write operation and commits to the effectuation of the transaction, otherwise it aborts the effectuation of the transaction. If all the replica locations commit, the write operations 30 are actually carried out and confirmed by the respective databases 13 and 14 via a confirmation 31. The client 10 receives the new value CRC2 of the checksum of the written data object by means of a return 32.

Meanwhile, during a processing 33, the client 11 has locally changed the original data object read by him and sends a request 34 containing the checksum CRC1 originally sent to him to the database management system 8, to overwrite the data object with the new contents. The database management system 8 asks for the data object stored under cipher key S1 of the local database 14 via a call 35. The local database 14 returns the data object overwritten by the client to the database management system 8 in a reply 36. In a self-interrogation 37 the database management system 8 calculates the checksum CRC2 of this data object. The self-interrogation 37 compares the calculated checksum CRC2 with the checksum CRC1 transferred to it by the client 11 in the request 34 and establishes that the checksums do not match. For this reason the client 11 is informed via an error message 38 that his write operation has gone wrong. The database management system 8 has detected that the client 11 has not read the data object having the contents changed by the client 10, but only knows the originally stored data object.

The client 11 or the application behind the client 11 may now decide either to dispense with the writing or to read the object anew, change it and write it again. Since the checksums would match after the second reading, the write access could be performed successfully.

Alternatively, the distributed database management system 8 can manage methods of merging various changes and implement them after lost update problems have been discovered and thus enable the writing nevertheless.

1. A network comprising network nodes (1 to 3) and a software system distributed over all the network nodes, which software system comprises a database management system (7 to 9) which is provided for calculating a characterizing unit of the data object when a user referred to as a client (10 to 12) accesses a data object of the database management system (7 to 9), and the characterizing unit is provided for being transferred to the client (10 to 12) and the client (10 to 12) is provided for storing the characterizing unit.

2. A network as claimed in claim 1, characterized in that the database management system (7 to 9) is provided for comparing the characterizing unit stored at the client (10 to 12) with the actual characterizing unit, in that the database management system (7 to 9) is provided for executing the write access if the characterizing units match, and in that the database management system (7 to 9) is provided for executing alternative actions if the characterizing units do not match.

3. A network as claimed in claim 2, characterized in that the remote database management system (7 to 9) receives a change indication and a characterizing unit in a respective joint message when there is a distributed write operation.
